(19) United States
(12) Patent Application Publication
(10) Pub. No.: US 2011/0256764 A1
(43) Pub. Date: Oct. 20, 2011

(54) LOW PROFILE CABLE CONNECTOR ASSEMBLY

(75) Inventor: JERRY WU, Irvine, CA (US)

(73) Assignee: HON HAI PRECISION INDUSTRY CO., LTD., New Taipei (TW)

(21) Appl. No.: 13/089,332

(22) Filed: Apr. 19, 2011

(30) Foreign Application Priority Data
Apr. 19, 2010 (CN) 201020162732.8

(51) Int. Cl. H01R 13/648; H01R 24/00

(52) U.S. Cl. 439/607.01; 439/626

(57) ABSTRACT

A cable connector assembly (100), comprises: a plurality of first contacts (2), an insulative housing (1) molding outside the first contacts (2), a plurality of second contacts (3) received in the housing (1), a flat cable (4) connecting with the first contacts (2) and the second contacts (3), and the cable (4) comprising a plurality of inner conductors (40) arranged on upper and lower row, the upper row of the inner conductors (40) soldered to the second contacts (3) and the lower row of the inner conductors (40) soldered to the first contacts (2), a metallic shell (5) shielding outside the insulative housing (1).

### 1. FIELD OF THE INVENTION

The present invention generally relates to a cable connector assembly, and more particularly to a low profile cable connector assembly.

### 2. DESCRIPTION OF RELATED ART

Universal Serial Bus (USB) is a serial bus standard to the PC architecture with a focus on computer telephony interface, consumer and productivity applications. The interface design of USB is standardized by the USB Implementers Forum (USB-IF), an industry standardized organization founded by computer and communication companies. And USB cables used to connect peripherals such as mouse devices, keyboards, PDAs, gamepads and joysticks, scanners, digital cameras, printers, external storage, networking components, etc. For many devices such as scanners and digital cameras, USB has become the standard connection method.

Taiwan Patent Publication No. 357095 discloses a USB 3.0 connector assembly. The previous USB plug has a round cable and a metallic shell enclosing the cable, so the USB plug has a high profile. Thus, the tradition USB plug can not meet the miniaturization developing trend.

Correspondingly, it is desired to have a cable connector assembly with improved structure to address the problems stated above.

### BRIEF SUMMARY OF THE INVENTION

Accordingly, an object of the present invention is to provide a cable connector assembly with low profile.

In order to achieve the above-mentioned object, A cable connector assembly, comprising: a plurality of first contacts, an insulative housing molding outside the first contacts, a plurality of second contacts received in the housing, a flat cable connecting with the first contacts and the second contacts, and the cable comprising a plurality of inner conductors arranged on upper and lower row, the upper row of the inner conductors soldered to the second contacts and the lower row of the inner conductors soldered to the first contacts, a metallic shell shielding outside the insulative housing.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an exploded, perspective view of a cable connector assembly in accordance with the present invention;

FIG. 2 is similar to FIG. 1, but viewed from another aspect;

FIG. 3 is a perspective, partial assembled view of the cable connector assembly of FIG. 1;

FIG. 4 is a perspective, partial assembled view of the electrical connector assembly when a top shell and a cover are removed;

FIG. 5 is similar to FIG. 4, but viewed from another aspect;

FIG. 6 is an assembled, perspective view of the cable connector assembly of FIG. 1;

FIG. 7 is a cross-sectional view of the cable connector assembly taken along line 7-7 of FIG. 6;

FIG. 8 is a cross-sectional view of the cable connector assembly taken along line 8-8 of FIG. 6;

### DETAILED DESCRIPTION OF THE INVENTION

Reference will now be made to the drawing figures to describe the present invention in detail.

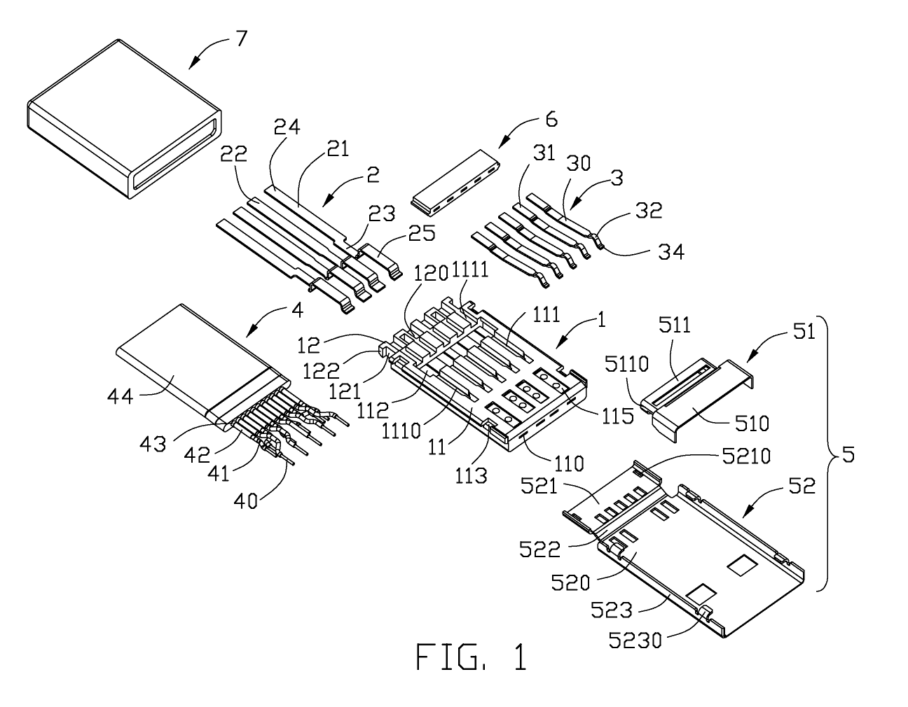

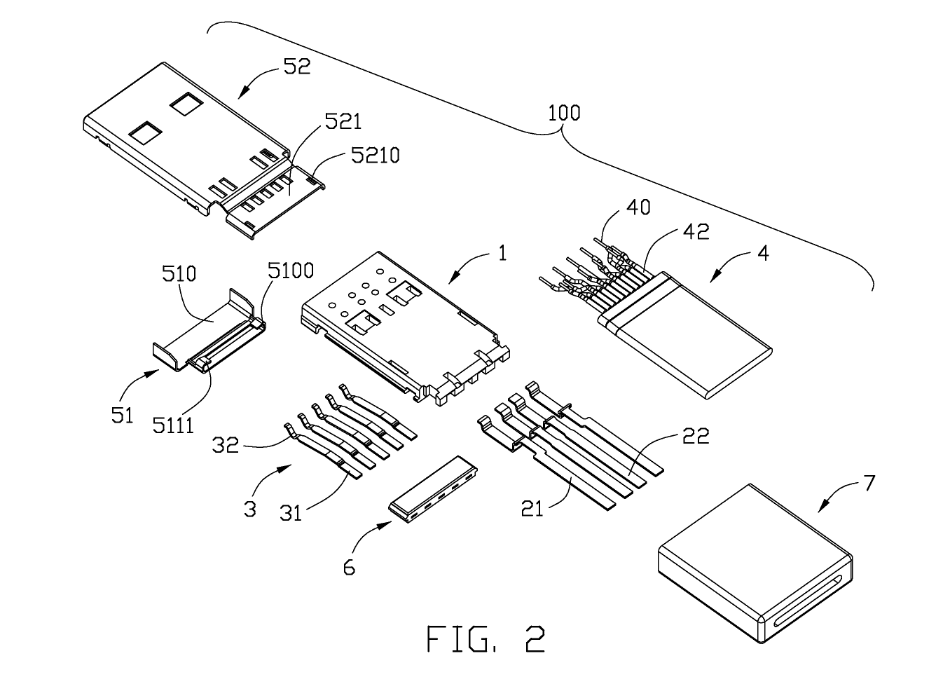

Referring to FIGS. 1 to 2, a cable connector assembly 100 in accordance with the present invention is according with the USB 3.0 standard, and the cable connector assembly 100 comprises a plurality of first contacts 2, an insulative housing 1 molding outside the contacts 1, a plurality of second contacts 3 received in the insulative housing 1, cable 5 connecting with the first contacts 2 and the second contacts 3, and a metallic shell 5 shielding outside the insulative housing 1.

Referring to FIGS. 1 to 2, the insulative housing 1 comprise a base portion 11 and a tongue portion 12 extending rearwardly from the base portion 11. A plurality of terminal receiving passages 110 are defined in the base portion 11 and extend along a mating direction of the cable connector assembly 100. A plurality of terminal receiving grooves 111 formed in an upper surface of the base portion 11 for receiving the second contacts 3. A step-shaped portion 114 is formed in the lower section of the front surface of the terminal receiving grooves 111 and extended forwardly and downwardly. And in this way, the terminal receiving grooves 111 connecting with the terminal receiving passages 110 along the perpendicular direction. The transverse surface of the step-shaped portion 114 defines a bottom wall 1113. A groove 112 is recessed downwardly from the upper surface of the insulative housing 1 to divide the terminal receiving grooves 111 into a front section and a back section, and the front section defines a plurality of first receiving grooves 1110, and the back section defines a plurality of second receiving grooves 1111. A plurality of supporting grooves 120 formed in an upper surface of the tongue portion 12 and the supporting grooves 120 are respectively in alignment with the terminal receiving passages 110 along a front-to-back direction. Two rows of locking holes 113 are recessed downwardly from the two side walls of the upper surface of the base portion 11. A pair of bumps 122 are formed in the two lateral walls 121 of the tongue portion 12 and extending outwardly.

Referring to FIGS. 1 to 2, the number of the first contacts 2 is four, and two outside first contacts are defined as power contacts 21, and two inside first contacts are defined as signal contacts 22. Each contact 2 comprises a retention portion 23 and a tail portion 24 extending backwardly from the retention portion 20 and a mating portion 25 extending upwardly and forwardly from the retention portion 23. The tail portion 24 is beyond the back surface of the base portion 11 and the mating portion 25 is exposed on the upper surface of the insulative housing 1. The mating portions 25 are received in the terminal receiving passages 110 and the upper surface of the mating portions 25 are exposed in the grooves 115. The retention portions 23 are received in the terminal receiving passages 110, and the tail portions 24 are supported in the supporting grooves 120.

Referring to FIGS. 1 to 2, the number of the second contacts 3 are five, and each second contact 2 comprises a base portion 30, a tail portion 31 extending rearwardly from the base portion 30 and a mating portion 32 extending forwardly from the base portion 32. The mating portions 32 are exposed on the upper surface of the insulative housing 1, and the mating portions 32 are installed behind the mating portions 25. And a tail end 34 is formed in the end of the mating portion 32 and extending forwardly.

Referring to FIGS. 1 to 2, the cable connector assembly 100 also comprises a spacer 6 and the spacer 6 molding outside the back-section of the base portion 30 of the second contacts 3.

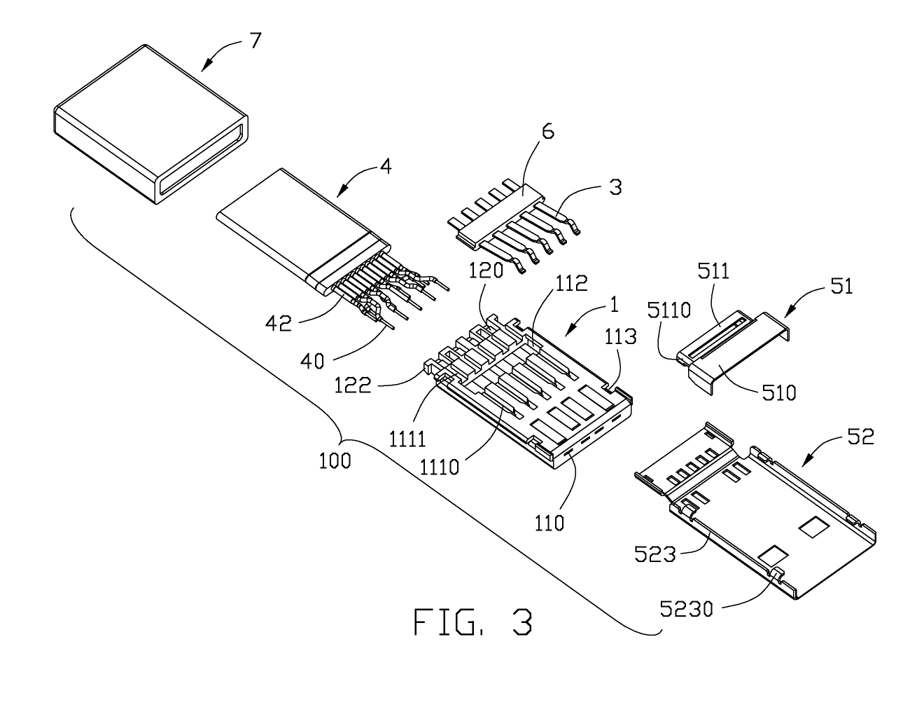

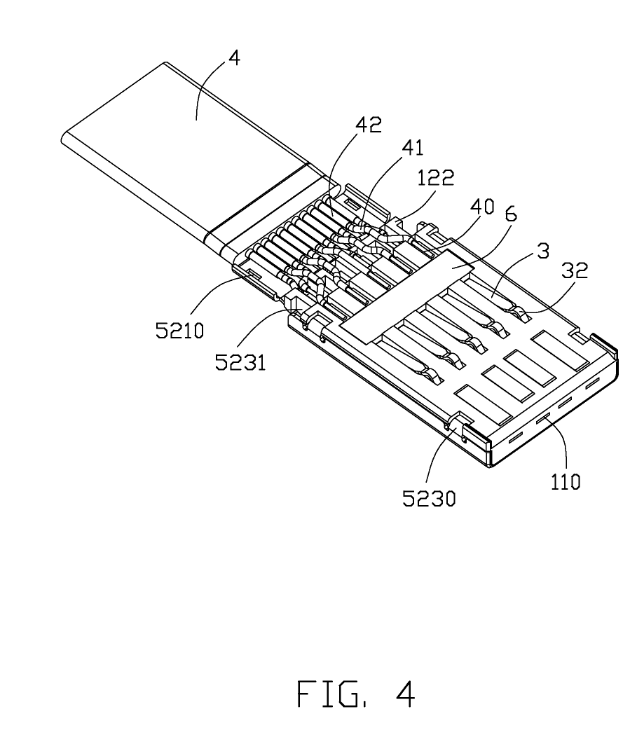

Referring to FIGS. 1 to 2, the cable 4 comprises a plurality of wires, each wire comprises an inner conductor 40, an inner insulative layer 41 enclosing the inner conductor 40, a braiding layer 42 enclosing the inner insulative layer 41 and an outer insulative layer 43 enclosing the braiding layer 42. Besides, the cable 4 also comprises an insulative jacket 44 enclosing the wires. Please referring to FIGS. 1 to 2, the inner conductor 40 is exposed from the front edge of the inner insulative layer 41, the insulative layer 41 is exposed from the front edge of the braiding layer 42 and the braiding layer 42 is exposed from the front edge of the outer insulative layer 43, and all of the outer insualtive layers 43 are exposed from the front edge of the insulative jacket 44 together. The cable connector assembly 100 of the present invention, the wires connecting with the first contacts 2 are departed from the wires connecting with the second contacts 3. The number of the inner conductors 40 connecting with the first contacts 2 is six and the inner conductors 40 arranged in a lower row. And the number of the inner conductors 40 connecting with the second contacts 3 is five and the inner conductors 40 arranged in an upper row. Please referring to the FIGS. 1 to 2 and in conjunction with FIGS. 3 to 4, the connecting method between the first contacts 2 and the second contacts 3 with the cable 4 of the present cable connector assembly 100 are as described: one of the upper row inner conductors 40 is connected with a second contact 3, the lateral two inner conductors 40 of the lower inner conductors 40 are connected with a power contact 21 at the same time, and one of the lower inner conductors 40 is connected with a signal contact 22.

Referring to FIGS. 1 to 2, the metallic shell comprises a top shell 51 and a bottom shell 52 assembled to each other along a vertical direction. The top shell 51 comprises a shielding portion 510 and a extending portion 511 extending rearwardly from the shielding portion 510. A pair of tabs 5111 are formed on the lateral walls 5110 of the extending portion 511 and extended inwardly from two lateral walls 5110. The bottom shell 52 comprises a shielding portion 520 enclosing the bottom surface of the insualtive housing 1, a supporting portion 521 disposed behind the shielding portion 520 for supporting the braiding layer 42 and a connection 522 connecting the shielding portion 520 and the supporting portion 521 for supporting the tongue portion 12. A pair of locking tabs 5230 are formed on two lateral walls 523 of the bottom shell 52 for receiving into the locking holes 113. And a pair of holes 5210 are formed in the support portion 521 for locking with tabs 5111. The holes 5210 extending through out the upper surface and lower surface of the support portion 521.

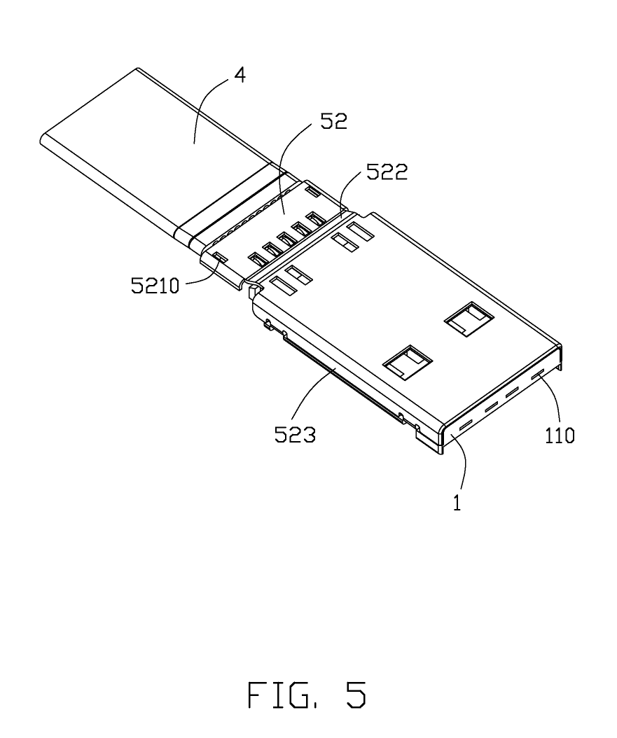

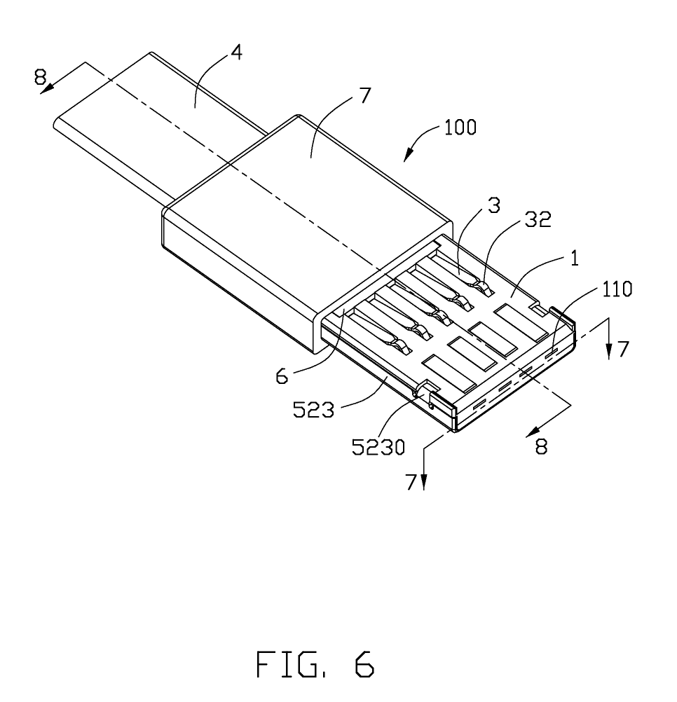

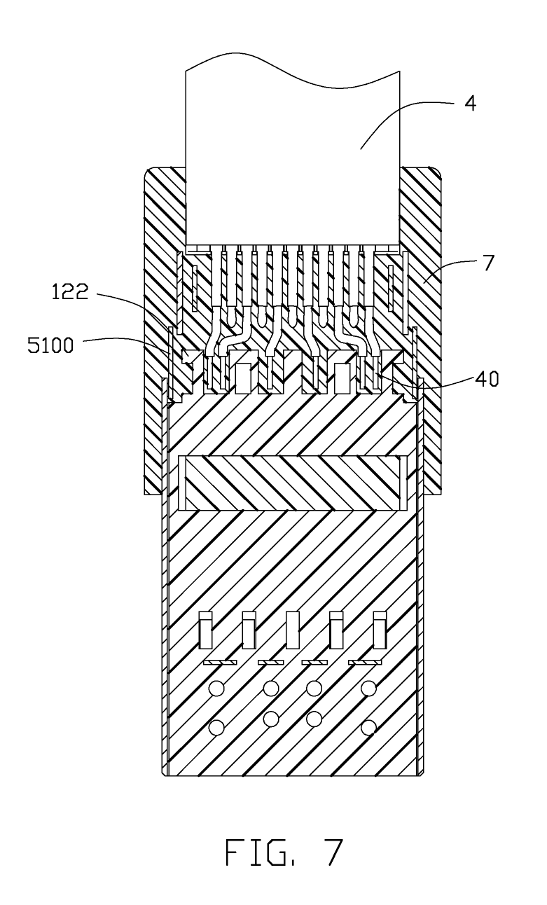

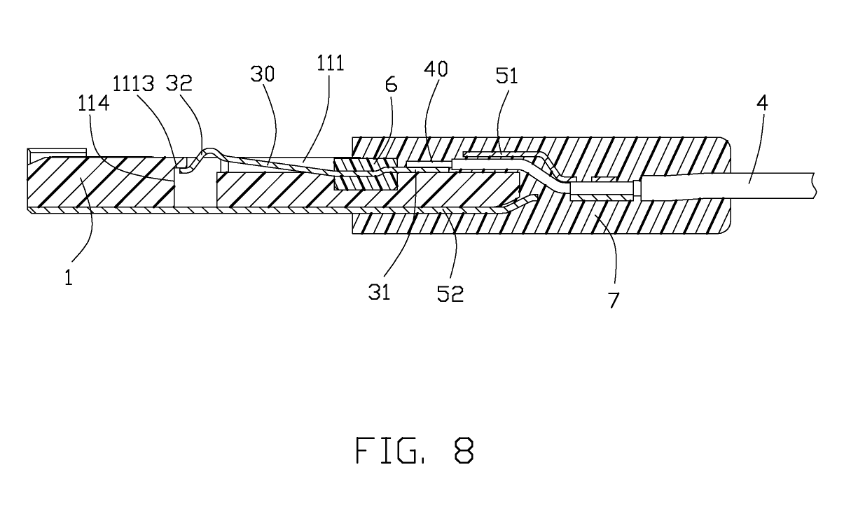

Referring to FIG. 1 to 2 and in conjunction with FIG. 3 to 8, in assembled with the cable connector assembly 100, the contacts 2 are received in the insulative housing 1 via the insert-molding process, the contacts 2 are received in the terminal receiving passages 110 and the tail portion 22 of the contacts 2 are received in the terminal receiving grooves 120; and the spacer 6 molding outside the second contacts 3 and assembling onto the upper surface of the insulative housing 1, the mating portions 32 and the front edge of the base portions 30 are received in the first receiving grooves 1110, and the tail portions 31 of the second contacts 3 are received in the second receiving grooves 1111, and the tail ends 34 of the second contacts 3 are received into the front edge of the first receiving grooves 1110 and closed with the bottom surface of the bottom wall 1113; the spacer 6 is disposed in the grooves 112; then the bottom shell 52 is assembled in the bottom surface of the insulative housing 1, the locking tabs 5230 are received into the locking holes 113, and at the same time, the tongue portion 12 is supported on the connection portion 522, the lower row of the inner conductors 40 are disposed in the supporting grooves 120 and the upper row of the inner conductors 40 are disposed in the second receiving grooves 1111, and the braiding layers 42 are disposed on the supporting portion 521, then the upper row of the inner conductors 40 soldered to the second contacts 3, one conductor 40 is connected with a second contact 3, and the lower row of the inner conductors 40 soldered to the first contacts 2, two inner conductors 40 are connected with a power contact 21 and one inner conductor 40 is connected with a signal contact 22, and the braiding layers 42 soldered to the supporting portion 521, a pair of gaps 5231 are formed between the posts 122 and the lateral wall 523 behind the locking tabs 5230, then the top shell 51 is assembled to the bottom shell 52 along a vertical direction perpendicular to the mating portion, the tabs 5111 are locked into the holes 5210 and the lateral walls 5100 are disposed in the gaps 5231, the top shell 51 is only shielding outside the tongue portion 12 and the conjunction portion between the cable 4 and the first contacts 2, and the top shell 51 is assembled to the supporting portion 521 of the bottom shell 52, and the cover 7 is molded outside of the back of the insulative housing 1, the conjunction portion of the cable 4 and the first contacts 2 and the second contacts 3 and partial of the cable 4. Thus, the cable connector assembly 100 is assembled.

The cable connector assembly comprises a flat-shaped cable 4 for connecting with the first contacts 2 and the second contacts 3. Because of the exist of the flat-shaped cable 4, the cable connector assembly 100 become low profile and meet with the requirement of the development of the cable connector assembly.

What is claimed is:

1. A cable connector assembly, comprising:
a plurality of first contacts;
an insulative housing molding outside the first contacts;
a plurality of second contacts received in the housing;
a flat cable connecting with the first contacts and the second contacts, and the cable comprising a plurality of inner conductors arranged on upper and lower row, the upper row of the inner conductors soldered to the second contacts and the lower row of the inner conductors soldered to the first contacts; and
a metallic shell shielding outside the insulative housing.

2. The cable connector assembly as claimed in claim 1, wherein a plurality of terminal receiving grooves are formed in an upper surface of the insulative housing for receiving the second contacts.

3. The cable connector assembly as claimed in claim 2, wherein a step-shaped portion formed in the lower section of the front surface of the terminal grooves and extended forwardly and downwardly.

4. The cable connector assembly as claimed in claim 3, wherein the step-shaped portion comprises a bottom wall extending along the horizontal direction.

5. The cable connector assembly as claimed in claim 4, wherein the insualtive housing comprises a base portion and a tongue portion extending rearwardly from the base portion.

6. The cable connector assembly as claimed in claim 5, wherein a plurality of supporting grooves are formed in an upper surface of the tongue portion and the supporting grooves are respectively in alignment with the terminal receiving passages along a front-to-back direction.

7. The cable connector assembly as claimed in claim 6, wherein each second contact comprises a base portion and a mating portion extending forwardly from the base portion.

8. The cable connector assembly as claimed in claim 7, wherein a tail end is formed in the end of the mating portion and the tail ends are received into the first receiving grooves and closed with the bottom surface of the bottom wall.

9. The cable connector assembly as claimed in claim 8, wherein each first contact comprises a retention portion and a tail portion extending backwardly from the retention portion, and the tail portions of the first contacts are supported in the supporting grooves.

10. The cable connector assembly as claimed in claim 2, wherein a groove is recessed downwardly from the upper surface of the insulative housing to divide the terminal receiving grooves into a front section and a back section.

11. The cable connector assembly as claimed in claim 10, wherein the cable connector assembly also comprises a spacer molding outside the second contacts and the spacer is disposed in the groove.

12. The cable connector assembly as claimed in claim 11, wherein the lower row of the inner conductors are disposed in the supporting grooves and the upper row of the inner conductors are disposed in the second receiving grooves.

13. A cable connector assembly, comprising:
an insulative housing having a top surface and a bottom surface thereof;
a plurality of first contacts and second contacts, each of the first contacts and the second contacts comprise a mating portion, and the mating portions of the first contacts and the second contacts are exposed on the upper surface of the insualtive housing, and the mating portions of the first contacts disposed in the front of the mating portions of the second contacts;
a cable connecting with the first contacts and the second contacts, and the cable comprising a plurality of inner conductors arranged on the upper and lower row, the upper row of the inner conductors soldered to the second contacts and the lower row of the inner conductors soldered to the first contacts;
a metallic shell comprising a shielding portion shielding the bottom surface of the insualtive housing;

14. The cable connector assembly as claimed in claim 13, wherein the metallic shell comprises a top shell and a bottom shell assembled with each other, and the shielding portion is formed on the bottom shell.

15. The cable connector assembly as claimed in claim 14, wherein the bottom shell also comprises a supporting portion extending rearwardly from the shielding portion and engaged with the top shell.

16. The cable connector assembly as claimed in claim 15, wherein the figure of the cable is flat-shaped, and comprises a plurality of wires, the front end of the wires are exposed and connected with the contacts.

17. An electrical connector comprising:
an insulative housing defining a mating tongue with a mating face thereon;
a plurality of first contacts disposed in the housing with non-deflectable contacting sections exposed upon the mating face, and first tail sections;
a plurality of second contacts disposed in the housing with deflectable contacting sections exposed upon the mating face, and second tail sections; and
a plurality of wires located behind the housing, each of said wires defining an inner conductor, an inner insulative layer enclosing the inner conductor, a braiding layer enclosing the inner insulative layer, and an outer jacket enclosing the braiding layer; wherein
the wires and the corresponding second contacts keep a one-to-one connection relation while the wires and some of the corresponding contacts keep a two-to-one connection relation.

18. The electrical connector as claimed in claim 17, wherein the second contacts are unified with one another by an insulator which is assembled into a corresponding cavity of the housing in a vertical direction perpendicular to a front-to-back direction.

19. The electrical connector as claimed in claim 17, further including a metallic shell including a front portion covering a face of the mating tongue opposite to said mating face, and a rear portion connecting to the braiding layer of the wires.

20. The electrical connector as claimed in claim 17, wherein remainder of the first contacts keeps the one-to-one connection relation with the corresponding wires.
